(19) United States
(12) Patent Application Publication
(10) Pub. No.: US 2009/0203416 A1
(43) Pub. Date: Aug. 13, 2009

(54) Gaming Machine Accepting Side Bet and Control Method Thereof

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/243,206

(22) Filed: Oct. 1, 2008

Related U.S. Application Data
(60) Provisional application No. 61/028,311, filed on Feb. 13, 2008.

(51) Int. Cl. A63F 9/24; A63F 13/00

(52) U.S. Cl. 463/16; 463/25

(57) ABSTRACT

A gaming machine of the present invention includes: a gaming portion in which a plurality of dice roll and stop; a station having an input device with which a normal BET and a side BET are able be placed, the normal BET being able to be placed on a total value of the outcomes of the plurality of dice as well as a value other than the total value, the side BET being able to be placed only on the total value of the outcomes of the plurality of dice in contrast to the normal BET; and a controller programmed to execute the processing of (C) rolling and stopping the plurality of dice in the gaming portion, (E) executing a feature game in which an amount of a special payout to be offered based upon the side BET is variable; and (F) offering the special payout based upon the outcomes of the plurality of dice stopped in the processing (C), the accepted side BET, and a result of the feature game executed in the processing (E).

### CROSS-REFERENCE TO RELATED APPLICATIONS

This application claims benefit of priority based on U.S. Provisional Patent Application No. 61/028,311 filed on Feb. 13, 2008. The contents of this application are incorporated herein by reference in their entirety.

### BACKGROUND OF THE INVENTION

1. Field of the Invention

The present invention relates to a gaming machine accepting a side BET and a control method thereof.

2. Discussion of the Background

There have been conventionally known a variety of table games, and for example, as disclosed in WO 07/016776-A1, US 2007/0026947-A1, and U.S. Pat. No. 5,413,351, a game genre called a dice game exists among those table games.

Among the dice games, there exists, for example, a gaming method in which a dealer throws dice after a player has performed a BET operation, and in the case where the dealer throws a predetermined combination, the player can throw dice to obtain a high payout, as disclosed in U.S. Pat. No. 5,413,351. Further, in Asia, Sic Bo is known as a long-time familiar dice game in which a player places a BET based on a prediction of the outcomes of three dice.

Sic Bo is widely known as an ancient Chinese dice game. In Sic Bo, a player places a BET based on a prediction of the outcomes of the respective three dice or a combination of the outcomes of the three dice. The way of placing a BET and payout rates are displayed on a table where a player is seated (or they may be displayed to an image display). The table is provided with: an area for placing a BET based on a prediction of the outcome of one die; an area for placing a BET based on a prediction that the outcomes of two dice will be the same; an area for placing a BET based on a prediction that the outcomes of the three dice will be the same; an area for placing a BET based on a prediction of a combination of the outcomes of two dice; an area for placing a BET based on a prediction of the total value of the outcomes of the three dice; and the like. As for the payout, although it cannot be uniformly set due to different circumstances of regions, countries, or the like, it has been set to the degree of 1:1 to 1:180 according to an appearance probability.

Since the dice game disclosed in U.S. Pat. No. 5,413,351 is executed according to a particular rule, there has been a problem that the game is unfamiliar to the player and lacks interesting aspects. Further, in typical Sic Bo widely known, types of BETs are limited and hence the player might soon be tired of the game.

An object of the present invention is to provide a gaming machine capable of enhancing interesting aspects of a game so as to prevent a player from becoming tired of the game, and a control method of the gaming machine.

The contents of WO 07/016776-A1, US 2007/0026947-A1, and U.S. Pat. No. 5,413,351 are incorporated herein by reference in their entirety.

### SUMMARY OF THE INVENTION

The present invention provides a gaming machine having the following configuration.

Namely, the gaming machine includes: a gaming portion in which a plurality of dice roll and stop; a station having an input device with which a normal BET and a side BET can be placed, the normal BET being able to be placed on a total value of the outcomes of the plurality of dice as well as a value other than the total value, the side BET being able to be placed only on the total value of the outcomes of the plurality of dice in contrast to the normal BET; and a controller. The controller is programmed to execute the processing of (A) accepting the normal BET from the input device in the station, (B) accepting the side BET from the input device in the station, (C) rolling and stopping the plurality of dice in the gaming portion, (D) offering a normal payout based upon the outcomes of the plurality of dice stopped in the processing (C) and the normal BET accepted in the processing (A), (E) executing a feature game in which an amount of a special payout to be offered based upon the side BET accepted in the processing (B) is variable; and (F) offering the special payout based upon the outcomes of the plurality of dice stopped in the processing (C), the side BET accepted in the processing (B), and a result of the feature game executed in the processing (E).

According to the above gaming machine, payouts with respect to two kinds of BETs, that is, a normal payout with respect to the normal BET and a special payout with respect to the side BET, are prepared. Therefore, a player has wider options in betting so as to be prevented from becoming tired of the game.

According to the above gaming machine, the feature game is executed. Namely, in the gaming machine, not only is the player made to repeatedly perform a series of operations of predicting the outcomes of dice and then determining whether or not the prediction comes true, but also the feature game is executed. This can make the player feel fun, and the interesting aspect of the game can be improved.

Further, the amount of the special payout to be offered based upon the side BET is variable depending on a result of the feature game. Therefore, execution of the feature game can make the player have an expectation that the special payout amount might be increased.

It is desirable that the gaming machine further have the following configuration.

The processing (F) is the processing of (F-1) determining a minimum special payout amount which is smaller than the amount of the normal payout to be offered with respect to the normal BET placed on the same betting object based upon the outcomes of the plurality of dice stopped in the processing (C) and the side BET accepted in the processing (B), and (F-2) offering the special payout in an amount based upon the minimum special payout amount determined in the processing (F-1) and the result of the feature game executed in the processing (E).

A special payout amount with respect to the side BET becomes larger or smaller than the amount of the normal payout to be offered with respect to the normal BET placed on the same betting object, depending upon a result of the chance game. Hence the player has a keen interest in the result of the chance game when having placed the side BET, and it is thereby possible to make the player enthusiastic about the game. Further, the player ponders which BET should be placed, the normal BET or the side BET, on the same betting object, and hence according to the above gaming machine, it is possible to make the player place a BET with a feeling of fun.

It is desirable that the gaming machine further have the following configuration.

The processing (E) is processing which is performed in a case where the side BET on the total value of the outcomes of the plurality of dice stopped in the processing (C) has been accepted in the processing (B).

When the side BET wins, the feature game is executed. Therefore, when seeing a feature game being executed, a player can be aware that a side BET placed by another player has won. Therefore, execution of the feature game can make other players wish to place a side BET. Further, it is possible to make a player whose side BET has won have a sense of superiority.

It is desirable that the gaming machine further have the following configuration.

The processing (E) is processing which is performed in a case where the total value of the outcomes of the plurality of dice stopped in the processing (C) is a specific number.

When the total value of the outcomes of dice is a specific number, the feature game is executed. Therefore, the player places the side BET, hoping the total value of the outcomes of dice to become the specific number. It is thereby possible to make the player excited about whether or not the total value of the outcomes of the dice will become the specific number.

The present invention further provides a method for controlling the gaming machine.

Namely, the controlling method includes a step of: (A) accepting a normal BET from an input device in a station with which a normal BET and a side BET are placed, the normal BET being able to be placed on a total value of the outcomes of the plurality of dice as well as a value other than the total value, the side BET being able to be placed only on the total value of the outcomes of the plurality of dice in a station. The controlling method also includes a step of (B) accepting the side BET from the input device in the station. Moreover, the controlling method includes a step of (C) rolling and stopping the plurality of dice in a gaming portion in which the plurality of dice roll and stop. Further, the controlling method includes a step of (D) offering a normal payout based upon the outcomes of the plurality of dice stopped in the step (C) and the normal BET accepted in the step (A). Furthermore, the controlling method includes a step of (E) executing a feature game in which an amount of a special payout to be offered based upon the side BET accepted in the step (B) is variable. Still furthermore, the controlling method includes a step of (F) offering the special payout based upon the outcomes of the plurality of dice stopped in the step (C), the side BET accepted in the step (B), and a result of the feature game executed in the step (E).

According to the method for controlling the gaming machine, two kinds of BETs and payouts, that is, the normal payout with respect to the normal BET and the special payout with respect to the side BET, are prepared. Therefore, the player has wider options in betting so as to be prevented from becoming tired of the game.

According to the method for controlling the gaming machine, a feature game is executed. Namely, in the method for controlling the gaming machine, not only is the player made to repeatedly perform a series of operations of predicting the value of the outcomes of dice and then determining whether or not the prediction comes true, but also the feature game is executed. This can make the player feel fun, and the interesting aspect of the game can be improved.

Further, the amount of the special payout to be offered based upon the side BET is variable depending on a result of the feature game. Therefore, execution of the feature game can make the player have an expectation that the special payout amount might be increased.

### BRIEF DESCRIPTION OF THE DRAWINGS

FIG. 1 is an exemplary view showing a display screen displayed to an image display.

FIG. 2 is a perspective view schematically showing one example of a gaming machine according to the present invention.

FIG. 3 is an enlarged view of a gaming portion of the gaming machine shown in FIG. 2.

FIG. 4 is a view schematically showing a channel from collection to release of dice in the gaming portion.

FIG. 5 is a block diagram showing an internal configuration of an outcome detecting device in the gaming machine shown in FIG. 2.

FIG. 6 is an exemplary view showing a display screen displayed to the image display.

FIG. 7 is a block diagram showing an internal configuration of the gaming machine shown in FIG. 2.

FIG. 8 is a block diagram showing an internal configuration of one of the stations shown in FIG. 2.

FIG. 9A is a flowchart showing game processing according to the present embodiment.

FIG. 9B is another flowchart showing game processing according to the present embodiment.

FIG. 9C is another flowchart showing game processing according to the present embodiment.

FIG. 10 is a flowchart showing feature game execution processing that is performed in a station.

FIG. 11 is a view showing one example of the displayed images displayed on the image display.

### DESCRIPTION OF THE EMBODIMENTS

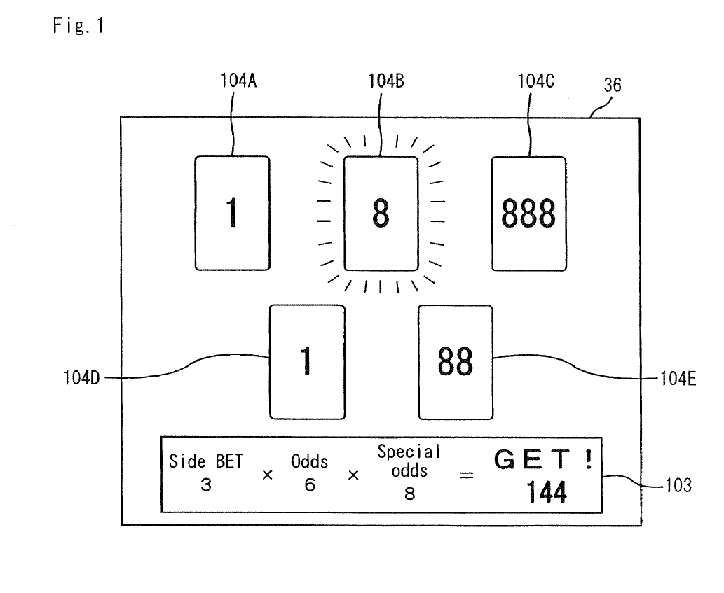

FIG. 1 is a view showing a characteristic of a gaming machine of the present embodiment, and an exemplary view showing a display screen displayed to an image display.

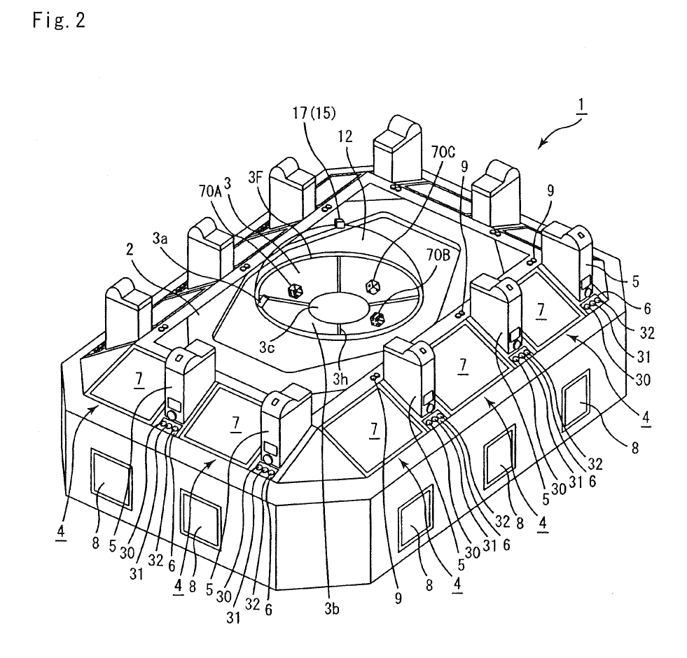

FIG. 2 is a perspective view schematically showing one example of gaming machines according to the present invention.

As shown in FIG. 2, a gaming machine 1 according to the present embodiment includes: a cabinet 2 to be a main body portion; a gaming portion 3 which is provided at the substantially central portion of the upper surface of the cabinet 2 and within which a plurality of dice 70 roll and stop; and a plurality of stations 4 provided so as to surround the gaming portion 3. Each of the stations 4 includes an image display 7. A player seated at each station 4 takes part in a game by entering a normal BET input and a side BET input in which a BET can be placed only on a total value of outcomes of the plurality of dice 70 based on a predicted value of the outcomes of the dice 70.

In FIG. 1, to a liquid crystal screen 36 in an image display 7, a card image 104A, a card image 104B, a card image 104C, a card image 104D, and a card image 104E are displayed. The card image 104B selected by the player is displayed in a different mode from those of other card images 104.

It is to be noted that a number displayed on the card image 104 corresponds to special odds to be referenced in determination of the specific payout amount. Namely, the card image 104A, the card image 104B, the card image 104C, the card image 104D, and the card image 104E respectively correspond to special odds 1, 8, 888, 1, and 88.

In FIG. 1, since 8 is displayed on the card image 104B selected by the player, the special odds is 8. A determined special payout amount image 103 is displayed which shows that the special payout will be offered in number obtained by multiplying 3 as the number of the side BET, 6 as a special payout odds and 8 as the special odds.

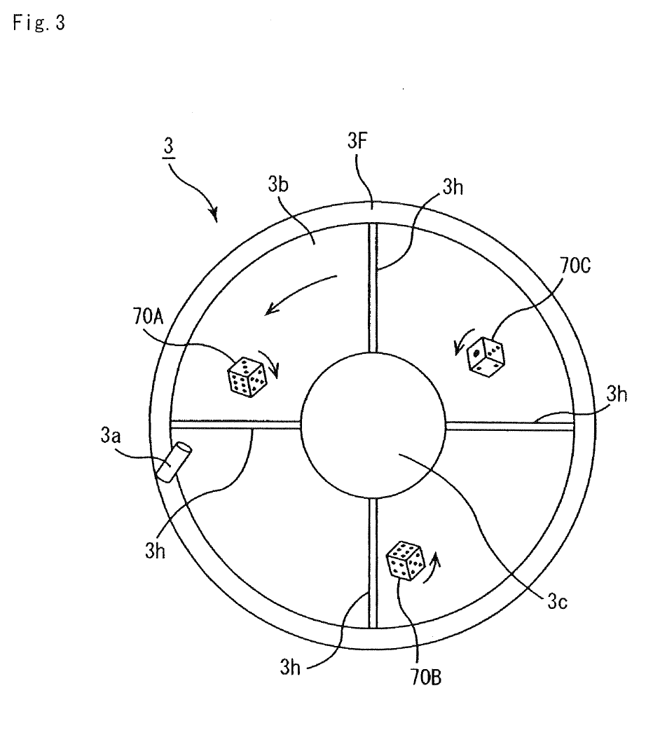

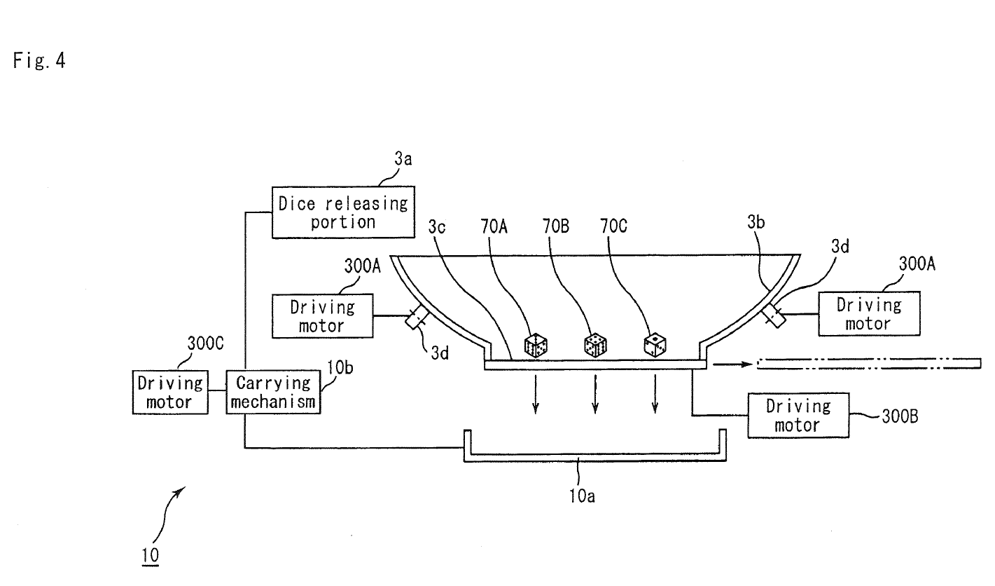

FIG. 2 is the perspective view schematically showing one example of the gaming machines according to the present invention; FIG. 3 is an enlarged view showing the gaming portion of the gaming machine shown in FIG. 2; and FIG. 4 is a view schematically showing a channel from collection to release of the dice in the gaming portion.

The gaming machine 1 includes: the cabinet 2 to be the main body portion; the gaming portion 3 which is provided at the substantially central portion of the upper surface of the cabinet 2 and in which the plurality of the dice 70 roll and stop; and the plurality of (10 units in the present embodiment) the stations 4 provided so as to surround the gaming portion 3.

Each of the stations 4 includes: a game media accepting device 5 into which game media such as medals for use in a game are inserted; a control portion 6 having a plurality of control buttons and the like, with which a player inputs predetermined commands; and the image display 7 to which an image regarding a BET table and the like are displayed. The player can participate in a game by operating the control portion 6 while watching the image displayed to the image display 7.

On the side surfaces of the cabinet 2 where the stations 4 are installed, there are provided for each station 4 a payout exit 8 from which the game media are paid out. Further, on the right side above the image display 7 of each station 4, speakers 9 capable of outputting a sound are provided.

The control portion 6 is provided beside the image display 7 of the station 4. In the control portion 6, a confirmation button 30, a payback button 31 and a help button 32 are arranged in the order from the left, when seen from a position facing to the station 4.

The confirmation button 30 is pressed when a BET operation is confirmed after the BET operation has been performed. Further, for operations other than the BET operations, the player also presses the confirmation button 30 to confirm an input that the player has entered.

The payback button 31 is typically pressed after a game has been ended. When the payback button 31 is pressed, game media according to credits owned by the player is paid back from the payout exit 8.

The help button 32 is pressed when the game playing manner or the like is unclear. Immediately after the help button 32 is pressed, a help image showing information on a variety of operations is displayed to the image display 7.

In the gaming portion 3, the plurality of the dice 70 are rolled and stopped. In the present embodiment, the gaming machine 1 has a configuration in which three dice 70 (a die 70A, a die 70B and a die 70C) are used in the gaming portion 3.

The gaming portion 3 is formed in a circular shape and includes: a dice releasing portion 3a from which the dice 70 are released; a rotating plate 3b to rotate the dice 70 which are sequentially released from the dice releasing portion 3a; and a stopping plate 3c that finally stops the dice 70 rotating on the rotating plate 3b.

The dice releasing portion 3a is installed in a circular outer frame 3F configuring the gaming portion 3, and from here, the dice 70A to 70C are sequentially (or simultaneously) released toward the rotating plate 3b. It is to be noted that in FIGS. 2 and 3, the dice 70 are drawn in a large size as compared with the dice releasing portion 3a for the sake of facilitating the description.

The rotating plate 3b has a shape of a truncated cone, as shown in FIG. 4. On the lower surface portion of the rotating plate 3b, a plurality of driving rollers 3d are rotatably provided in a state in contact with the rotating plate 3b. Simultaneously with start of a game, the plurality of the rotating rollers 3d are rotationally driven by a rotating-plate driving motor 300A, to rotationally drive the rotating plate 3b. It is to be noted that on the front surface of the rotating plate 3b, projections 3h are provided at predetermined intervals, which flip the respective dice so as to facilitate rolling thereof when the rotating plate 3b is rotationally driven.

The stopping plate 3c is configured in a circular plate shape at the bottom portion of the rotating plate 3b having a shape of a truncated cone, and is an area where the dice 70 rotating on the rotating plate 3b finally stop after dropping along the inclination of the rotating plate 3b following the stop of the rotating plate 3b. Namely, the dice 70 released from the dice releasing portion 3a rotate on the surface of the rotating plate 3b by rotation of the rotating plate 3b, and drop along the inclination of the rotating plate 3b with the stop of the rotating plate 3b. Then, the dice 70 finally stop on the stopping plate 3c.

As shown in FIG. 4, the stopping plate 3c is configured to be slidingly driven by a stopping-plate driving motor 300B. With the stopping plate 3c slidingly driven, the dice 70 drop toward a collection/release mechanism 10.

The collection/release mechanism 10 includes: a housing portion 10a that receives the dice 70 having dropped from the stopping plate 3c; a carrying mechanism 10b that carries the dice 70 inside the housing portion 10a toward the dice releasing portion 3a; and a carriage driving motor 300C that drives the carrying mechanism 10b. The configuration of the collection/release mechanism 10 is not limited to a specific form, so long as it is a configuration capable of collecting the dice 70 after a later-described outcome detecting device 15 has completed detection of the outcomes of the respective dice 70 having stopped on the stopping plate 3c, and releasing the dice 70 from the dice releasing portion 3a, toward the rotating plate 3b. Namely, for example, the carrying mechanism 10b can be conducted in a variety of forms, such as a configuration in which the carrying mechanism 10b carries the dice 70 by air pressure from the housing portion 10a toward the dice releasing portion 3a, and a configuration in which the carrying mechanism 10b carries the dice 70 by a conveyor-like carrier from the housing portion 10a toward the dice releasing portion 3a.

The gaming portion 3 is covered at its whole upper portion by a hemispheric covering member 12 made of transparent acrylic, and therefore the rotating range of the dice 70 is regulated. In the present embodiment, the outcome detecting device 15 that detects the outcomes of the dice 70 is installed on the top of the covering member 12. It is to be noted that in FIG. 2, the covering member 12 is drawn so as to cover only part of the gaming portion 3 for the sake of facilitating the description.

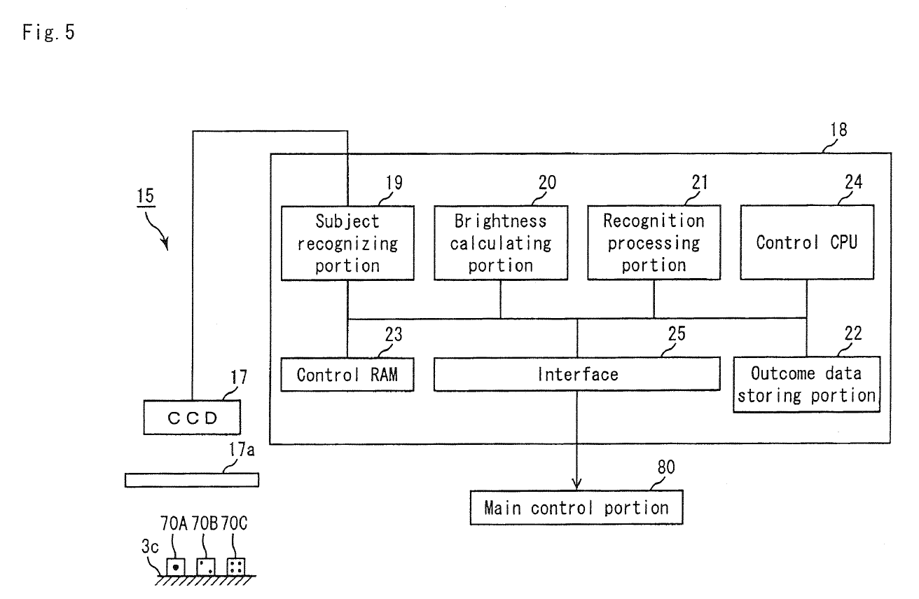

FIG. 5 is a block diagram showing an internal configuration of the outcome detecting device in the gaming machine shown in FIG. 2.

The outcome detecting device 15 in the present embodiment includes an imaging device (CCD camera) 17 that photographs the dice 70 being the object to be photographed, and an outcome detecting circuit 18 that processes the imaging signal from the imaging device 17 and then detects the outcomes of the dice 70.

The imaging device 17 is previously made by a focus lens 17a to have a focus consistent with the stopping plate 3c in order to photograph the dice 70 on the stopping plate 3c, and is exposure-controlled. The outcome detecting circuit 18 includes: a subject recognizing portion 19 that receives an imaging signal from the imaging device 17 to recognize a position of a subject (dice 70); a brightness calculating portion 20 that calculates brightness of the image of the subject (image of the dice) recognized in the subject recognizing portion 19; a recognition processing portion 21 that identifies the outcomes of the dice 70; an outcome data storing portion 22 in which comparison data regarding the outcomes of the dice 70 is stored; a control RAM 23; and a control CPU 24 that controls these units. These units are connected to one another through a bus, and controlled by the control CPU 24.

From the imaging signal of the dice 70 received from the imaging device 17, intensity distribution of the image is measured in the subject recognizing portion 19. Measuring the intensity distribution allows identification of the positions of the dice 70 on the stopping plate 3c and the surface states of the dice 70. In the recognition processing portion 21, the identified data is subjected to processing of comparison with the comparison data previously stored in the outcome data storing portion 22, to identify the outcomes of the dice 70.

The identified outcome information is stored into the control RAM 23, and transmitted to a later-described main control portion 80 through an interface 25. Namely, the outcome detecting device 15 identifies the outcomes of the three dice 70 having stopped in the gaming portion 3, and transmits the identified outcome information to the main control portion 80.

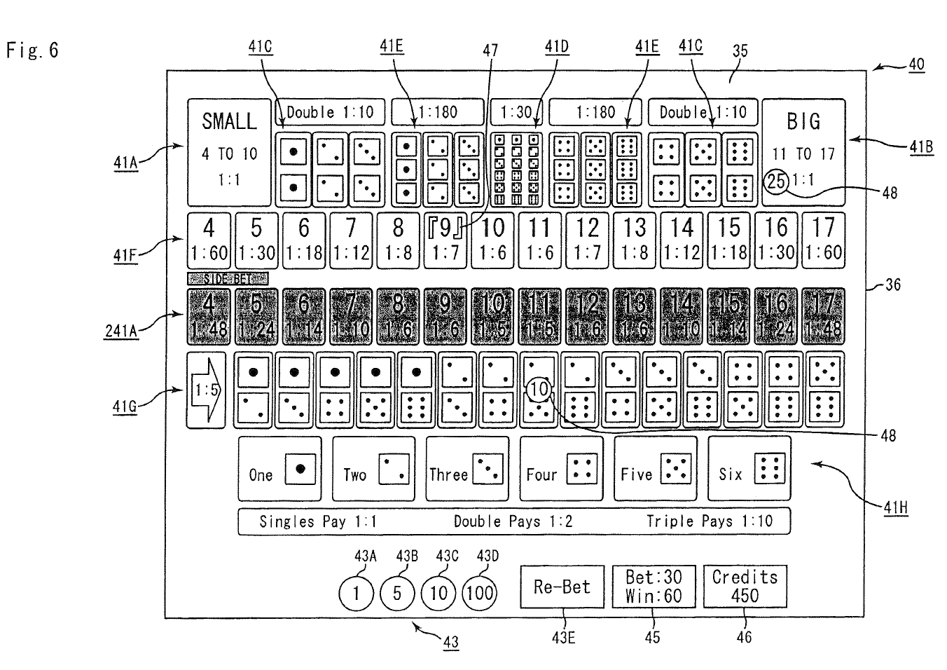

FIG. 6 is an exemplary view showing the display screen displayed to the image display.

As shown in FIG. 6, the image display 7 is a touch-panel-type liquid crystal display having a touch panel 35 installed on its front surface; the player can select an icon and the like displayed to the liquid crystal screen 36 by touching the touch panel 35 with his/her finger or the like.

During the game, a table-type betting board (BET screen) 40 to be used for predicting the outcomes of the dice 70 is displayed at a predetermined timing.

The following describes the BET screen 40 in more detail.

On the BET screen 40, a plurality of normal BET areas 41 (normal BET area 41A, normal BET area 41B, normal BET area 41C, normal BET area 41D, normal BET area 41E, normal BET area 41F, normal BET area 41G, normal BET area 41H) and a side BET area 241A is displayed. A normal BET operation is performed by touching the touch panel 35 with a finger or the like to specify the normal BET area 41, and making chips displayed on the specified normal BET area 41. Further, a side BET operation is performed by touching the touch panel 35 with a finger or the like to specify the side BET area 241A, and making chips displayed on the specified side BET area 241A.

In the lower portion of BET screen 40, there are displayed a unit BET button 43, a Re-BET button 43E, a payback result display portion 45, and a number-of-credits display portion 46 in order from the left.

The unit BET button 43 is used for betting a chip on the normal BET area 41 and the side BET area 241 A specified by the player. The unit BET button 43 is configured by four types of buttons: a 1-BET button 43A; a 5-BET button 43B; a 10-BET button 43C; and a 100-BET button 43D. It is to be noted that, when the BET operation is wrongly performed, it can be performed again by touching a Re-BET button 43E with the finger or the like.

The player first touches the touch panel 35 with the finger or the like to specify the normal BET area 41 or the side BET area 241A by using a cursor 47. At this state, touching the 1-BET button 43A with the finger or the like enables the player to BET one chip at a time (the number of BETs increases in order of 1, 2, 3, and so forth every time the 1-BET button 43A is touched with the finger or the like). Similarly, touching the 5-BET button 43B with the finger or the like enables the player to BET five chips at a time (the number of BETs increases in order of 5, 10, 15, and so forth every time the 5-BET button 43B is touched with the finger or the like). Touching the 10-BET button 43C with the finger or the like enables the player to BET ten chips at a time (the number of BETs increases in order of 10, 20, 30, and so forth every time the 10-BET button 43C is touched with the finger or the like). Touching the 100-BET button 43D with the finger or the like enables the player to BET one hundred chips at a time (the number of BETs increases in order of 100, 200, 300, and so forth every time the 100-BET button 43D is touched with the finger or the like). The number of BET chips up to the present moment is displayed as a chip mark 48, and a number displayed within the chip mark 48 shows the number of BETs of chips.

In a payback result display portion 45, the number of BETs of chips of the player and the number of payback credits in the previous game are displayed. A number obtained by subtracting the number of BETs from the number of payback credits indicates the number of credits newly acquired by the player in the previous game.

In the number-of-credits display portion 46, the number of credits owned by the player is displayed. This number of credits decreases according to the number of BETs (one credit per one chip) when chips are BET. Further, when the BET chips are won and credits are paid back, the number of credits increases by the number of the paid back credits. It is to be noted that, when the number of credits becomes 0, the game is ended.

Next, the normal BET areas 41 on the BET screen 40 are described.

The normal BET areas 41A, 41B are portions used when the player places a BET based on a prediction of the total value of the dice 70A to 70C. Namely, the normal BET area 41A is selected when the total value is predicted to be 4 to 10, and the normal BET area 41B is selected when the total value is predicted to be 11 to 17. The payout is set to 1:1 (two chips are paid out with respect to one BET).

The normal BET area 41C is a portion used when the player places a BET based on a prediction that the outcomes of two dice 70 out of the three dice 70 will be the same. Namely, the normal BET area 41C is used when the player places a BET based on a prediction that any of the combinations of the outcomes (1, 1), (2, 2), (3, 3), (4, 4), (5, 5) and (6, 6) will appear, out of the outcomes of the three dice 70; here, the payout is set to 1:10.

The normal BET area 41D is a portion used when the player places a BET based on a prediction that all of the outcomes of the three dice 70 will be the same. Namely, the normal BET area 41D is used when the player places a BET based on a prediction that the outcomes of the three dice 70 will be any of (1, 1, 1), (2, 2, 2), (3, 3, 3), (4, 4, 4), (5, 5, 5) and (6, 6, 6). The payout is set to 1:30.

The normal BET area 41E is a portion used when the player places a BET based on a prediction that all of the outcomes of the three dice 70 will be the same, and a prediction of the value that the three dice 70 will have. Namely, the normal BET area 41E is used when the player places a BET based on a prediction that the outcomes of the three dice 70 will be (1, 1, 1), (2, 2, 2), (3, 3, 3), (4, 4, 4), (5, 5, 5) or (6, 6, 6) and also a prediction of the value that the three dice 70 will have. The payout is set to 1:180.

The normal BET area 41F is a portion used when the player places a BET based on a prediction of the total value of the three dice 70. The payout is set according to an appearance probability of the total value: the payout is 1:60 when the total value is 4 or 17; 1:30 when the total value is 5 or 16; 1:18 when the total value is 6 or 15; 1:12 when the total value is 7 or 14; 1:8 when the total value is 8 or 13; 1:7 when the total value is 9 or 12; and 1:6 when the total value is 10 or 11.

The normal BET area 41 G is a potion used when the player places a BET based on a prediction of the outcomes of two dice 70 out of the three dice 70. The payout is set to 1:5.

The normal BET area 41H is a portion used when the player places a BET based on a prediction of the outcome of at least one die 70 out of the dice 70; the payout is set according to the number of the dice 70 with the outcome corresponding to the predicted outcome.

Next, the side BET area 241A of the BET screen 40 is described.

The side BET area 241A is a portion in which a BET is placed based on a prediction of a total value of the three dice 70. The payout is set in accordance with an appearance probability of the total value: the payout is 1:48 when the total value is 4 or 17; 1:24 when the total value is 5 or 16; 1:14 when the total value is 6 or 15; 1:10 when the total value is 7 or 14; 1:6 when the total value is 8 or 13; 1:6 when the total value is 9 or 12; and 1:5 when the total value is 10 or 11. The payout set in the side BET area 241A is low as compared with the payout set in the normal BET area 41 F for the same betting object.

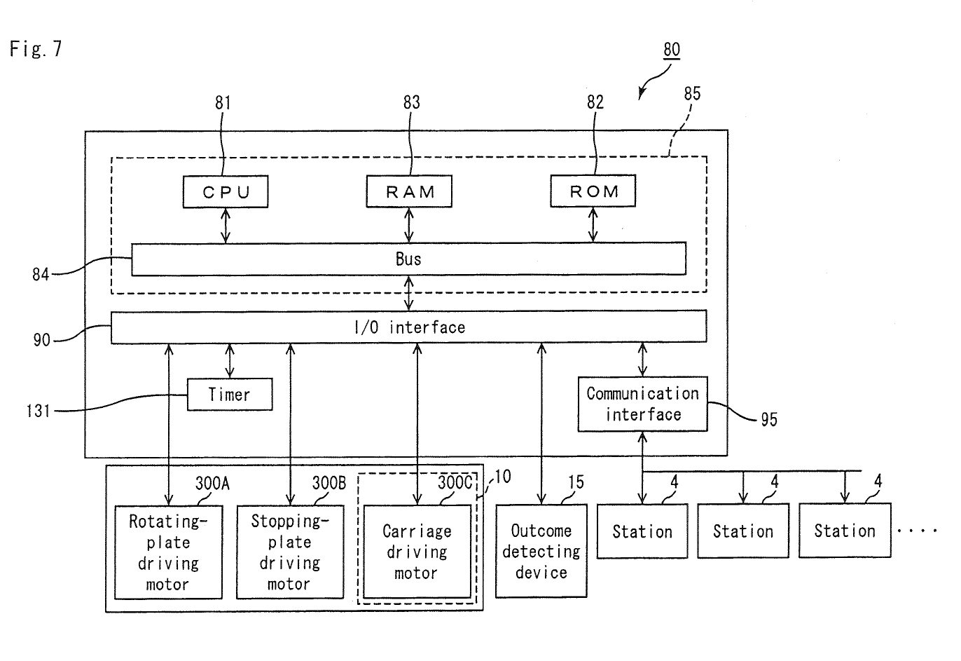

FIG. 7 is a block diagram showing an internal configuration of a main control portion 80 in the gaming machine shown in FIG. 2.

The main control portion 80 of the gaming machine 1 has a microcomputer 85, which mainly comprises a CPU 81, a ROM 82, a RAM 83, and a bus 84 that transfers data mutually thereamong.

The CPU 81 is connected to the rotating-plate driving motor 300A, the stopping-plate driving motor 300B and the carriage driving motor 300C, through an I/O interface 90. Further, through the I/O interface 90, the CPU 81 is connected to a timer 131 capable of measuring time. The I/O interface 90 is also connected with the foregoing outcome detecting device 15, and transmits and receives information on the outcomes of the three dice 70 having stopped on the stopping plate 3c, and the like, to and from the outcome detecting device 15. Moreover, the I/O interface 90 is connected with a communication interface 95; through this communication interface 95, the main control portion 80 transmits and receives data such as BET information, information on the outcome of the sub die 700, and payout information, to and from each station 4.

The ROM 82 of the main control portion 80 stores programs for realizing a basic function of the gaming machine 1, specifically a program for controlling a variety of devices for driving the gaming portion 3, a program for controlling each station 4, and the like, and also stores a payout table, data showing predetermined time T, data showing a specific value TT, and the like.

The RAM 83 is a memory that temporarily stores a variety of data calculated in the CPU 81. For example, the RAM 83 temporarily stores BET information transmitted from each station 4, information on the outcomes of the dice 70 transmitted from the outcome detecting device 15, data on results of processing executed by the CPU 81, and the like.

Based on the data and programs stored in the ROM 82 and the RAM 83, the CPU 81 controls the rotating-plate driving motor 300A, the stopping-plate driving motor 300B and the carriage driving motor 300C which drive the gaming portion 3, throws the dice 70 onto the rotating plate 3b of the gaming portion 3, and performs some other operations. Further, the CPU 81 executes control processing associated with the proceeding of the game, such as processing of checking the outcome of each of the dice 70 having stopped on the stopping plate 3c.

In addition to the control processing associated with the proceeding of the game, the CPU 81 has the function of controlling each station 4 so as to make the game proceed, by transmitting and receiving data to and from each station 4. Specifically, the CPU 81 receives BET information transmitted from each station 4. Further, based on the outcomes of the dice 70 and the BET information transmitted from each station 4, the CPU 81 performs winning determination processing, to calculate an amount of payout to be paid out at each station 4 with reference to the payout table stored in the ROM 82.

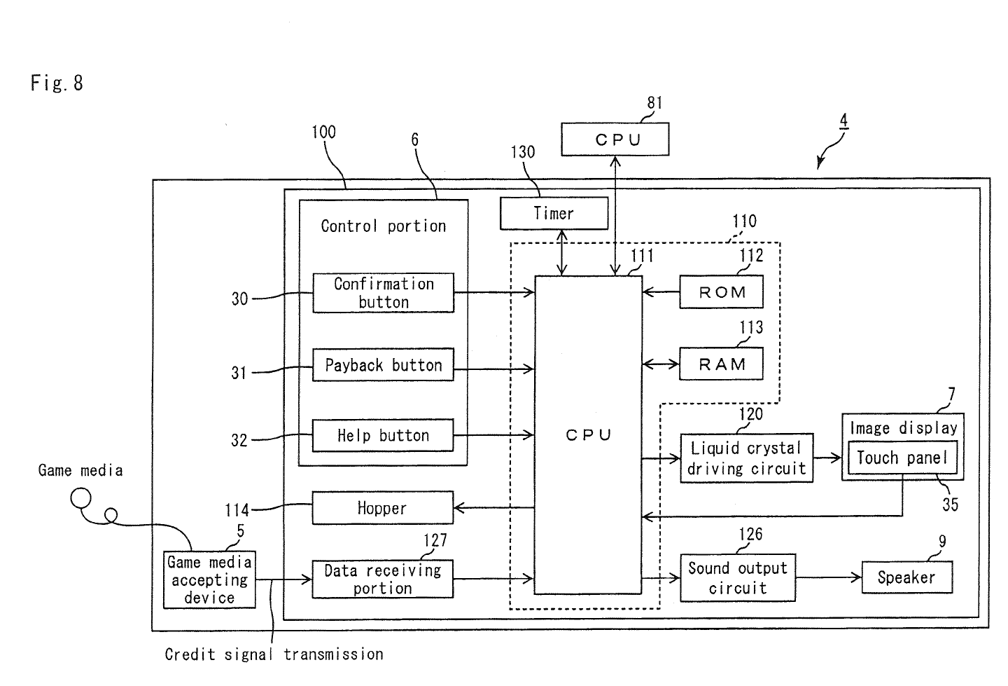

FIG. 8 is a block diagram showing an internal configuration of the station shown in FIG. 2.

The station 4 includes a main body portion 100 provided with the image display 7 and the like, and the game media accepting device 5 installed on the main body portion 100. Further, the main body portion 100 includes a station-controlling portion 110 and several peripheral devices.

The station-controlling portion 110 includes a CPU 111, a ROM 112, and a RAM 113.

The ROM 112 stores a program for realizing a basic function of the station 4, a variety of programs necessary for controlling the station 4, data for showing predetermined time RR, a data table, and the like.

The RAM 113 is a memory that temporarily stores a variety of data calculated in the CPU 111, the number of credits owned by the player, the state of BETs placed by the player, and the like.

The CPU 111 is connected separately with the confirmation button 30, the payback button 31, and the help button 32 which are provided in the control portion 6. Further, based on an operation signal output at the press of each button or the like, the CPU 111 performs control so as to execute a variety of operations corresponding to the signal. Specifically, the CPU 111 executes a variety of processing, based on an input signal that is supplied from the control portion 6 when the player has input an operation and on the data and programs stored in the ROM 112 and the RAM 113, and transmits the results of the processing to the CPU 81 of the main control portion 80.

Further, the CPU 111 receives a command signal from the CPU 81 of the main control portion 80, to control the peripheral devices constituting the station 4. Moreover, the CPU 111 executes a variety of processing, based on input signals supplied from the control portion 6 and the touch panel 35 and on the data and programs stored in the ROM 112 and the RAM 113. Based on the results of the processing, the CPU 111 controls the peripheral devices constituting the station 4. It is to be noted that which method is to be applied in performing the processing is set for each processing according to the content of the processing. For example, the processing of paying out game media corresponds to the former, and the BET operation processing by the player corresponds to the latter.

The CPU 111 is connected with a hopper 114, and the hopper 114 pays out a predetermined number of game media from the payout exit 8 based on a command signal from the CPU 111.

The CPU 111 is connected with the image display 7 through a liquid crystal driving circuit 120. The liquid crystal driving circuit 120 includes a program ROM, an image ROM, an image control CPU, a work RAM, a VDP (video display processor), a video RAM, and the like. The program ROM stores an image control program regarding display to the image display 7 and a variety of selection tables. The image ROM stores, for example, dot data for forming an image displayed to the image display 7, and dot data for displaying a card image 101 and the card image 104. Further, based on parameters set in the CPU 111, the image control CPU determines an image to be displayed to the image display 7 out of the dot data previously stored inside the image ROM, according to the image control program previously stored inside the program ROM. Moreover, the work RAM is configured as a temporary storage means in execution of the image control program in the image control CPU. Further, the VDP forms an image according to the display contents determined by the image control CPU, and outputs the image to the image display 7. It is to be noted that the video RAM is configured as a temporary storage means in formation of an image by the VDP.

The touch panel 35 is installed on the front surface of the image display 7, as described above, and information on the operation of the touch panel 35 is transmitted to the CPU 111. The touch panel 35 detects an input operation performed by the player on the BET screen 40 and the like. Specifically, selection of the normal BET areas 41 of the BET screen 40 and the BET area 241 of the side BET screen 60, input using the unit BET buttons 43 and the like are performed by the operation of touching the touch panel 35, and the information of the operation is transmitted to the CPU 111. Based on the information, BET information of the player is stored in the RAM 113. Further, the BET information is transmitted to the CPU 81 of the main control portion 80, and stored in the BET information storage area in the RAM 83.

Further, the sound output circuit 126 and the speakers 9 are connected to the CPU 111, and the speakers 9 generate a variety of effect sounds when a variety of effects are produced based on output signals from the sound output circuit 126. Moreover, the CPU 111 is connected with the game media accepting device 5 functioning as a device into which game media such as medals or currency are inserted. A data receiving portion 127 receives a credit signal transmitted from the game media accepting device 5, and the CPU 111 increases the number of credits of the player stored in the RAM 113 based on the transmitted credit signal.

The CPU 111 is connected with a timer 130 capable of measuring time.

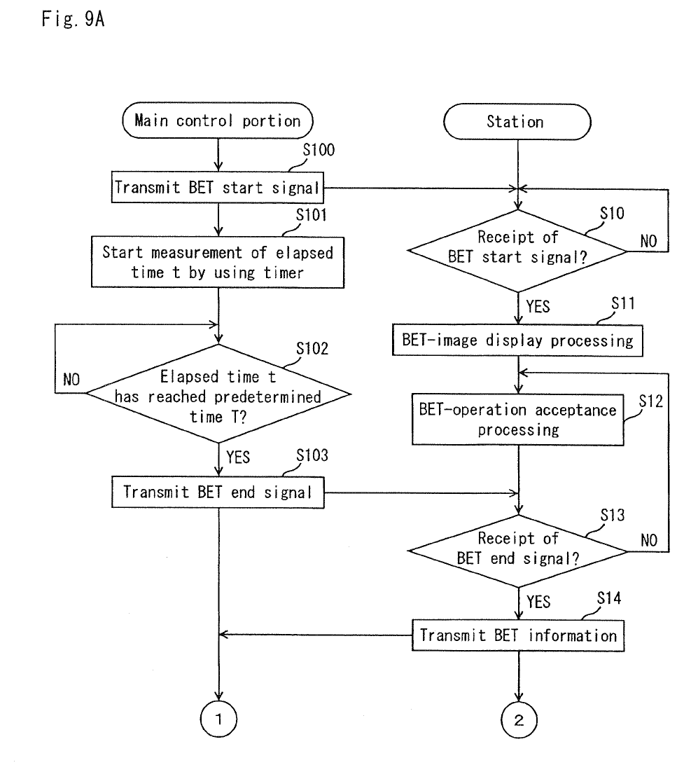

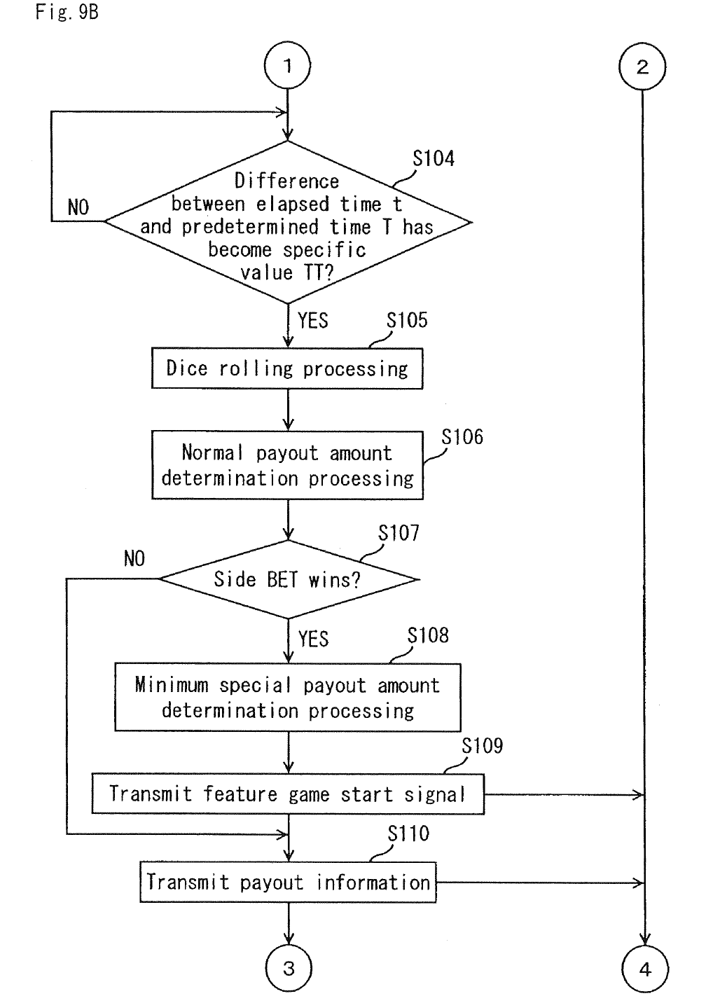

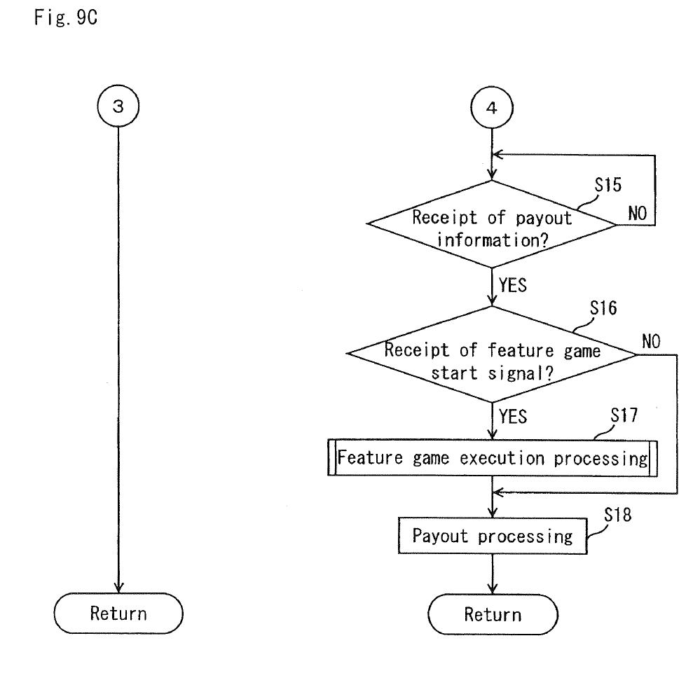

FIG. 9A to FIG. 9C are flowcharts showing game processing according to the present embodiment.

It is to be noted that in FIG. 9A to FIG. 9C, only processing in one of the stations 4 is shown for preventing complexity.

The main control portion 80 performs operations of steps S100 to S110.

First, in step S100, the CPU 81 transmits a BET start signal to each station 4.

In step S101, the CPU 81 starts measurement of elapsed time t by using the timer 131. Next, the CPU 81 compares the elapsed time t measured by the timer 131 with data indicating predetermined time T stored in the ROM 82, and then determines whether or not the elapsed time t measured by the timer 131 has reached the predetermined time T (step S102).

When determining in step S102 that the elapsed time t has not reached the predetermined time T, the CPU 81 returns the processing to step S102. On the other hand, when determining in step S102 that the elapsed time t has reached the predetermined time T, the CPU 81 transmits a BET end signal to each station 4 (step S103).

The CPU 81 determines whether or not the difference between the elapsed time t measured by the timer 131 and the predetermined time T stored in the ROM 82 has become a specific value TT stored in the ROM 82 (step S104). In the processing, the CPU 81 first subtracts the predetermined time T stored in the ROM 82 from the elapsed time t measured by the timer 131. The CPU 81 further compares the numeric value obtained by the subtraction with the specific value TT stored in the ROM 82, and determines whether or not the numeric value obtained by the subtraction has become the specific value TT stored in the ROM 82. By appropriately setting data showing the specific value TT, setting can be made such that processing of rolling the dice 70 can be performed at a desired timing.

When determining in step S104 that the difference between the elapsed time t and the predetermined time T has not become the specific value TT, the CPU 81 returns the processing to step S104. On the other hand, when determining in step S104 that the difference between the elapsed time t and the predetermined time T has become the specific value TT, the CPU 81 shifts the processing to step S105.

The CPU 81 executes processing of rolling the dice 70 in step S105. In the processing, based on the data and programs stored in the ROM 82 and the RAM 83, the CPU 81 controls the rotating-plate driving motor 300A, the stopping-plate driving motor 300B and the carriage driving motor 300C so as to perform control of throwing in the dice 70, control of rolling the dice 70, control of stopping the dice 70, and the like. Further, the CPU 81 executes control processing associated with the proceeding of the game, such as processing of checking the outcome of each of the dice 70 having stopped on the stopping plate 3c and the like.

In step S106, the CPU 81 executes normal-payout amount determination processing. In the processing, the CPU 81 executes winning determination processing, based on the information on the outcomes of the dice 70 having stopped on the stopping plate 3c and the BET information received from each station 4. The CPU 81 then calculates an amount of normal payout to be paid out at each station 4 with reference to the payout table stored in the ROM 82.

In step S107, the CPU 81 determines whether or not the side BET has won. In this processing, the CPU 81 determines whether or not the side BET has won based upon the information on the value of the outcomes of the dice 70 having stopped on the stopping plate 3c and the BET information received from each station 4.

When determining in step S107 that the side BET has not won, the CPU 81 shifts the processing to step S110. On the other hand, when determining in step S107 that the side BET has won, the CPU 81 shifts the processing to step S108.

In step S108, the CPU 81 performs minimum special payout amount determining processing. In this processing, the CPU 81 calculates the minimum amount of the special payout to be paid out at each station 4 with reference to a payout table stored in the ROM 82 based upon the information on the value of the outcomes of the dice 70 having stopped on the stopping plate 3c and the BET information received from each station 4. For example, when the side BET is placed with one chip on a betting object based on a prediction that the total value of the three dice 70 will be 7 and the side BET then won, since the payout is 1:10 as shown in FIG. 6, the minimum special payout amount is 11.

In step S109, the CPU 81 transmits a feature game start signal to each station 4.

The CPU 81 transmits payout information to each of the stations 4. In this processing, the CPU 81 transmits information on the amount of normal payout determined in the step S106 to each of the stations 4. Further, when performing the minimum special-payout amount determination processing in step S108, the CPU 81 transits to each station 4 the information on the minimum special payout amount determined in step S108.

Meanwhile, each station 4 executes respective operations of steps S10 to S18.

First, in step S10, the CPU 111 determines whether or not a BET start signal has been received from the main control portion 80. When determining that the BET start signal has not been received, the CPU 111 returns the processing to step S10. On the other hand, when determining that the BET start signal has been received, the CPU 111 shifts the processing to step S11.

The CPU 111 executes BET-image display processing in step S11. In the processing, the CPU 111 displays the BET screen 40 shown in FIG. 6 to the image display 7.

The CPU 111 executes BET-operation acceptance processing in step S12. In the processing, the CPU 111 accepts a normal BET input and a side BET input by the player through the touch panel 35.

Next, the CPU 111 determines whether or not a BET end signal has been received from the main control portion 80 (step S13). When determining that the BET end signal has not been received, the CPU 111 returns the processing to step S12. On the other hand, when determining that the BET end signal has been received, the CPU 111 shifts the processing to step S14.

The CPU 111 transmits the BET information to the main control portion 80 in step S14. In the processing, the CPU 111 transmits to the main control portion 80 information regarding the normal BET input and the side BET input, the information having been accepted in step S12, as BET information. It is to be noted that the BET information includes the identification number of the station 4.

The CPU 111 determines whether or not payout information from the main control portion 80 has been received (step S15). When determining that the payout information has not been received, the CPU 111 returns the processing to step S15. On the other hand, when determining that the payout information has been received, the CPU 111 shifts the processing to step S16.

The CPU 111 determines whether or not the feature game start signal from the main control portion 80 has been received (step S16). When determining that the feature game start signal has not been received, the CPU 111 shifts the processing to step S18. On the other hand, when determining that the feature game start signal has been received, the CPU 111 shifts the processing to step S17.

In step S17, the CPU 111 performs feature game execution processing. In this processing, the CPU 111 performs processing of executing the feature game to determine the special payout amount. This feature game execution processing will be specifically described later using a drawing.

In step S18, the CPU 111 performs payout processing. In this processing, the CPU updates the number of credits of the player stored in the RAM 113, and also updates displays of a payout result display portion 45 and a number-of-credits display portion 46, based on the payout information received form the main control portion 80.

It is to be noted that, when executing the feature game execution processing, the CPU 111 updates the number of credits of the player stored in the RAM 113, and also updates displays of a payout result display portion 45 and a number-of-credits display portion 46, based upon the special payout amount determined in the feature game execution processing and the payout information received from the main control portion 80.

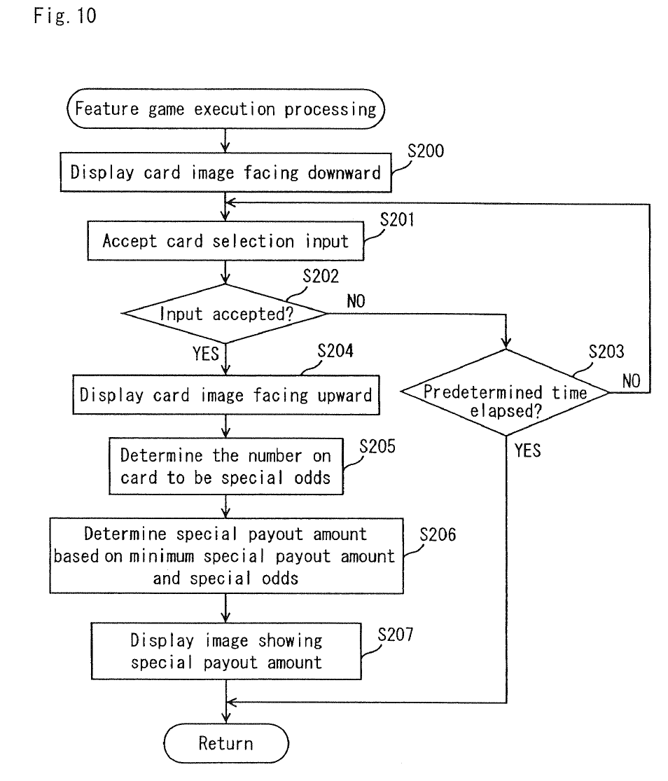

FIG. 10 is a flowchart showing the feature game execution processing that is performed in the station.

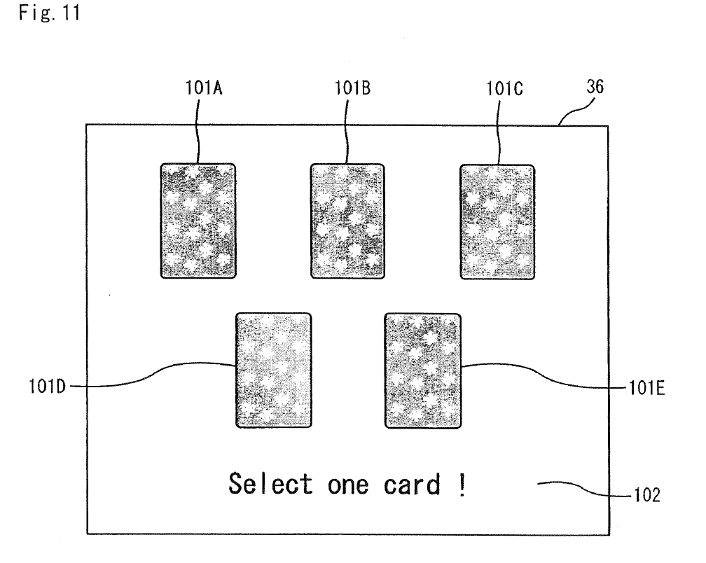

First, in step S200, the CPU 111 displays a card image facing downward to the image display 7. One example of the card images displayed to the image display 7 is shown in FIG. 11.

FIG. 11 is a view showing one example of the displayed images displayed on the image display.

In FIG. 11, a card image 101A, a card image 101B, a card image 101C, a card image 101D, and a card image 101E are displayed. The player can select the card image 101 displayed on the liquid crystal screen 36 by touching the touch panel 35 with a finger or the like.

Returning to FIG. 10, in step S201, the CPU 111 accepts a card selection input. Further, the CPU 111 starts measuring elapsed time r using the timer 130.

Next, the CPU 111 determines whether or not the input indicating selection of the card image 101 has been made through the touch panel 35 (step S202).

When determining in step S202 that the input has not been made, the CPU 111 shifts the processing to step S203. The CPU 111 determines whether or not the predetermined time has elapsed (step S203). In this processing, the CPU 111 compares the elapsed time r measured using the timer 130 with data showing predetermined time RR stored in the ROM 112, to determine whether or not the elapsed time r measured using the timer 130 has reached the predetermined time RR. When determining in step S203 that the predetermined time has not been elapsed, the CPU 111 shifts the processing to step S201. On the other hand, when determining that the predetermined time has elapsed, the CPU 111 completes the present routine.

When determining in step S202 that the input has been made, the CPU 111 displays the card image facing upward to the image display 7 (step S204). One example of the card images displayed to the image display 7 is shown in FIG. 1.

FIG. 1 is a view showing one example of the displayed images displayed to the image display.

In FIG. 1, the card image 104A, the card image 104B, the card image 104C, the card image 104D, and the card image 104E are displayed. The card image 104B selected by the player is displayed in a different mode from those of other card images 104.

It is to be noted that a number displayed on the card image 104 corresponds to special odds that is referenced in determination of a specific payout amount. Namely, the card image 104A, the card image 104B, the card image 104C, the card image 104D, and the card image 104E respectively correspond to special odds 1, 8, 888, 1, and 88.

For example, when the side BET is placed with three chips on a betting object based on a prediction that the total value of the three dice will be 10, and then the side BET won, since the payout is 1:5 (payout odds: six times) as shown in FIG. 6, the minimum special payout amount is 18. In FIG. 1, since 8 is displayed on the card image 104B selected by the player, the special odds is 8. Namely, in this case, the special payout is offered to the player in number obtained by multiplying 3 as the number of the side BET, 6 as the payout odds and 8 as the special odds. The image showing the amount of the special payout to be offered is displayed as the determined special payout amount image 103 to the image display 7.

As shown in FIG. 1, when the card image 104A or the card image 104D which displays 1 is selected, the amount of the special payout to be offered with respect to the side BET is small as compared with the amount of a normal payout offered with respect to a normal BET when placed on the same betting object. On the other hand, when the other card image 104 is selected, the amount of the special payout to be offered with respect to the side BET is large as compared with the amount of the normal payout that is offered with respect to the normal BET when placed on the same betting object.

Returning to FIG. 10, in step S205, the CPU 111 determines the number displayed on the card image selected by the player to be the special odds.

The CPU 111 determines the special payout amount based upon the minimum special payout amount included in the payout information received from the main control portion 80 and the special odds determined in step S205 (step S206).

The CPU 111 displays a determined special payout amount image 103 showing the special payout amount determined in step S206 to the image display 7 (step S207).

As described above, according to the above gaming machine 1 and the method for controlling the gaming machine 1, payouts with respect to two kinds of BETS, that is, the normal payout with respect to the normal BET and the special payout with respect to the side BET, are prepared. Therefore, the player has wider options in betting so as to be prevented from becoming tired of the game.

According to the above gaming machine 1 and the method for controlling the gaming machine 1, the feature game is executed. Namely, in the gaming machine 1 and the method for controlling the gaming machine 1, not only is the player made to repeatedly perform a series of operations of predicting the outcomes of the dice 70 and then checking whether or not the prediction comes true, but also the feature game is executed. This can make the player feel fun, and the interesting aspect of the game can be improved.

Further, in accordance with a result of the feature game, the amount of the special payout to be offered based upon the side BET is variable. Therefore, executing the feature game can make the player have an expectation for increase of the special payout amount.

The special payout amount with respect to the side BET becomes larger or smaller than the amount of the normal payout to be offered with respect to the normal BET placed on the same betting object, depending upon a result of a chance game. Hence the player has a keen interest in the result of the chance game when having placed the side BET, and it is thereby possible to make the player enthusiastic about the game. Further, the player ponders which BET will be placed, the normal BET or the side BET, and hence according to the above gaming machine 1 and the method for controlling the gaming machine 1, it is possible to make the player place a BET with a feeling of fun.

Therefore, when seeing a feature game being executed, a player can be aware that a side BET placed by another player has won. Therefore, execution of a feature game can make other players wish to place a side BET. Further, it is possible to make a player whose side BET has won have a sense of superiority.

Although the case was described in the present embodiment where the feature game is executed when the side BET wins, the timing for executing the feature game is not particularly limited in the present invention, and for example, the feature game may be executed when the total value of the outcomes of the plurality of dice is a specific number.

Although the case was described in the present embodiment where the feature game is a game of selecting a card image displayed on the image display 7, the feature game in the present invention is not particularly limited thereto so long as it is a game in which the amount of the special payout to be offered based upon the side BET is variable. For example, it may be a game in which, a reel installed in the station is rotated and then stopped, and the amount of the special payout to be offered is determined based upon a symbol drawn on the reel. Further, it may be a game in which a symbol is variably displayed on the image display 7 and then stopped and displayed, and the amount of the special payout to be offered is determined based upon the symbol stopped and displayed.

Although the case has been described in the present embodiment where the real dice 70 roll in the gaming portion 3, a configuration may be adopted in the present invention in which a main image display is installed separately from the image display provided in the station and an image showing the state of rolling of the dice is displayed to the main image display, without using real dice.

In this case, the CPU 81 is connected, through the I/O interface 90, with a random number generator 130B and a liquid crystal driving circuit 120B equivalent to the liquid crystal driving circuit 120 provided in the station 4. Further, the CPU 81 is connected with a main image display 701 through the liquid crystal driving circuit 120B.

The CPU 81 determines the outcome of each of the dice 70 by means of a random number. The CPU then displays an image showing the state of rolling of the dice 70 to the main image display 701. The CPU 81 further displays an image showing the dice 70 in a state of stopping with the outcomes of the determined value to the main image display 701.

Although the embodiment of the present invention in which the real dice 70 rotate in the gaming portion 3 has been described in the above, the present invention may also include a configuration in which the real dice are not used but an image showing dice in a state of rolling is displayed to the image display in the station.

In this case, the CPU is connected to a random number generator 130B through the I/O interface 90.

The CPU 81 determines the outcome of each of the dice 70 by means of a random number, and transmits information on the determined value of the outcome of each of the dice 70 to each station 4. Each station 4 then displays an image showing the dice 70 in a state of rolling to the image display 7. Further, an image showing the dice 70 in a state of stopping is displayed to the image display 7 based upon the received information on the value of the outcome of each of the dice 70.

Although the case has been described in the present embodiment where the image display is not installed in any place other than the station 4, a configuration may be adopted in the present invention in which the main image display is installed in the gaming machine separately from the image display provided in the station and an image showing the state of rolling of the dice in the gaming portion is displayed to the main image display.

In this case, the CPU 81 is connected, through the I/O interface 90, with a dice photographing device 701 having a CCD camera 17B and the liquid crystal driving circuit 120B equivalent to the liquid crystal driving circuit 120 provided in the station 4. Further, the CPU 81 is connected with the dice photographing device 701 through the liquid crystal driving circuit 120B. The CCD camera 17B provided in the dice photographing device 701 is installed at an angle that allows photographing of the gaming portion 3.

The CPU 81 displays an image showing the state of rolling of the dice 70 in the gaming portion 3 to the main image display 701, based on the signal transmitted from the dice photographing device 701.

Although the case was described in the present embodiment where the image of the dice 70 is not displayed to the image display 7 in the station 4, the present invention may also include a configuration in which an image showing the dice in a state of rolling in the gaming portion is displayed to the image display in the station.

In this case, the CPU 81 is connected to a dice photographing device 701 equipped with a CCD camera 17B through the I/O interface 90. The CCD camera 17B in the dice photographing device 701 is installed at such an angle as to be able to photograph the gaming portion 3.

The CPU 81 transmits a signal transmitted from the dice photographing device 701 to each station. The CPU 111 then displays to the image display 7 an image showing the dice 70 in a state of rolling in the gaming portion 3 based upon the signal received from the main control portion 80.

Although the case has been described in the present embodiment where the outcomes of the dice 70 are detected using the CCD camera 17, the method for detecting the outcomes of the dice is not particularly limited in the present invention. For example, an identifiable device, such as a device reactive to magnetism, may be previously imbedded inside each of the dice, and its outcome may be detected by the use of a magnetic change in the device. Moreover, an optical sensor may be used to detect the outcomes of the dice.

Although the case has been described in the present embodiment where the dice 70 are rolled using the rotating-plate driving motor 300A, the stopping-plate driving motor 300B and the carriage driving motor 300C, the method for rolling the dice is not particularly limited; for example, a configuration may be adopted in which the dice are rolled on a vibration plate. Further, the dice may not be collected, but maybe in a constantly exposed state inside the gaming portion.

Although the case was described in the present embodiment where the number of the dice 70 is three, the number of die is not restricted in the present invention, and for example, the number of die may be five.

Although the case has been described in the present embodiment where the controller in the present invention includes the CPU 81 provided in the main control portion 80 and the CPU 111 provided in the station 4, the controller in the present invention may be configured by a single CPU.

Although the present invention has been described with reference to embodiments thereof, these embodiments merely illustrate specific examples, not restrict the present invention. The specific structures of respective means and the like can be designed and changed as required. Furthermore, there have been merely described most preferable effects of the present invention, as the effects of the present invention, in the embodiments of the present invention. The effects of the present invention are not limited to those described in the embodiments of the present invention.

Further, in the aforementioned detailed description, characteristic portions have been mainly described, for ease of understanding the present invention. The present invention is not limited to the embodiments described in the aforementioned detailed description, but can be also applied to other embodiments over a wider range of applications. Further, the terms and phrases used in the present specification have been used for clearly describing the present invention, not for limiting the interpretation of the present invention. Further, those skilled in the art will easily conceive other structures, systems, methods and the like which are included in the concept of the present invention, from the concept of the present invention described in the present specification. Accordingly, the description of the claims is intended to include equivalent structures that fall within the technical scope of the invention. Further, the abstract aims at enabling engineers and the like who belong to the present technical field but are not familiar with the patent office and public institutions, the patent, law terms and technical terms to immediately understand the technical content and the essence of the present application through brief studies. Accordingly, the abstract is not intended to restrict the scope of the invention which should be evaluated from the description of the claims. It is desirable that literatures and the like which have been already disclosed are sufficiently studied and understood, in order to sufficiently understand the objects of the present invention and the specific effects of the present invention.

In the aforementioned detailed description, there has been described processing to be executed by computers. The aforementioned description and expressions have been described for the sake of enabling those skilled in the art to understand the present invention most effectively. In the present specification, each step for deriving a single result should be understood to be self-consistent processing. Further, each step includes transmission, reception, recording and the like of electric or magnetic signals. Although, in the processing at each step, such signals have been expressed as bits, values, symbols, characters, terms, numerical characters and the like, it should be noticed that they have been merely used for convenience of description. Further, although the processing at each step was described using expressions common to human behaviors in some cases, the processes described in the present specification are to be executed by various types of devices, in principle. Further, other structures required for conducting each step will be apparent from the aforementioned description.

What is claimed as new and desired to be secured by Letters Patent of the United States is:

1. A gaming machine, comprising:
a gaming portion in which a plurality of dice roll and stop;
a station having an input device with which a normal BET and a side BET can be placed, said normal BET being able to be placed on a total value of the outcomes of said plurality of dice as well as a value other than the total value, said side BET being able to be placed only on the total value of the outcomes of said plurality of dice in contrast to the normal BET; and
a controller, said controller programmed to execute the processing of
(A) accepting said normal BET from said input device in said station,
(B) accepting said side BET from said input device in said station,
(C) rolling and stopping said plurality of dice in said gaming portion,
(D) offering a normal payout based upon the value of the outcomes of said plurality of dice stopped in said processing (C) and said normal BET accepted in said processing (A),
(E) executing a feature game in which an amount of a special payout to be offered based upon said side BET accepted in said processing (B) is variable; and
(F) offering said special payout based upon the outcomes of said plurality of dice stopped in said processing (C), said side BET accepted in said processing (B), and a result of the feature game executed in said processing (E).

2. The gaming machine according to claim 1, wherein said processing (F) comprises
(F-1) determining a minimum special payout amount which is smaller than the amount of the normal payout to be offered with respect to the normal BET placed on the same betting object based upon the outcomes of said plurality of dice stopped in said processing (C) and said side BET accepted in said processing (B), and
(F-2) offering the special payout in an amount based upon the minimum special payout amount determined in said processing (F-1) and the result of the feature game executed in said processing (E).

3. The gaming machine according to claim 1,
wherein said processing (E) is performed in a case where the side BET on the total value of the outcomes of said plurality of dice stopped in said processing (C) has been accepted in said processing (B).

4. The gaming machine according to claim 1,
wherein said processing (E) is performed in a case where the total value of the outcomes of said plurality of dice stopped in said processing (C) is a specific number.

5. A method for controlling the gaming machine, comprising the steps of:
(A) accepting a normal BET from an input device with which a normal BET and a side BET are placed, said normal BET being able to be placed on a total value of the outcomes of said plurality of dice as well as a value other than the total value, said side BET being able to be placed only on the total value of the outcomes of said plurality of dice in contrast to the normal BET;
(B) accepting said side BET from said input device in said station;
(C) rolling and stopping said plurality of dice in a gaming portion in which said plurality of dice roll and stop;
(D) offering a normal payout based upon the outcomes of said plurality of dice stopped in said step (C) and said normal BET accepted in said step (A);
(E) executing a feature game in which an amount of a special payout to be offered based upon said side BET accepted in said step (B) is variable; and
(F) offering said special payout based upon the outcomes of said plurality of dice stopped in said step (C), said side BET accepted in said step (B), and a result of the feature game executed in said step (E).
